(19) United States
(12) Patent Application Publication
(10) Pub. No.: US 2025/0094896 A1
(43) Pub. Date: Mar. 20, 2025

(54) Artificial Intelligence System for Forward Looking Scheduling

(71) Applicant: MCKINSEY & COMPANY, INC., New York, NY (US)

(72) Inventors: Sohrab Rahimi, Summit, NJ (US); Zhekun Xiong, Boston, MA (US); Artem Avdeev, Stockholm (SE); Nicolai von Bismarck, Boston, MA (US)

(21) Appl. No.: 18/370,262

(22) Filed: Sep. 19, 2023

(51) Int. Cl. G06Q 10/0631

(52) U.S. Cl. CPC G06Q 10/063118

(57) ABSTRACT

Systems and methods of leveraging artificial intelligence (AI) for forward looking scheduling are disclosed. An example method comprises receiving a set of demand data and a set of schedules data corresponding to a first period for a service provider, and inputting the set of demand data and the set of schedules data into an optimization model trained to generate optimal schedules based on a set of training demand data and a set of training schedules data. The example method further comprises generating, by executing the optimization model, an optimal schedule for the first period based on the set of demand data and the set of schedules data; and outputting the optimal schedule for display to a user associated with the service provider.

### FIELD OF THE DISCLOSURE

The present disclosure is directed to improvements in demand forecasting. More particularly, the present disclosure is directed to systems and methods of leveraging artificial intelligence (AI) for forward looking scheduling.

### BACKGROUND

Workforce management generally involves optimizing various aspects of an organization s resources to ensure efficient operation. There are several consistent/ubiquitous challenges in workforce management, for which no universal solution has yet been provided. For example, conventional approaches struggle to appropriately balance labor costs and productivity. Organizations desire to find an optimal balance between minimizing labor costs and maximizing productivity, which involves efficiently allocating resources, reducing overtime expenses, and avoiding overstaffing or understaffing while meeting the corresponding service level agreement (SLA) target(s).

Conventional techniques also suffer from a relative inability to efficiently determine optimal resource allocation during run-time operations, incorporate cross-industry solutions, and/or comply with labor laws and regulations. These conventional techniques may generally encounter inefficiencies due to runtime complexity for large numbers of decision variables in typical solutions. Moreover, the problem statement for each workforce (e.g., call-center vs back-office) may be different because each workforce may have dramatically different requirements for service level(s) and average handle time for each task, and conventional techniques may be unable to account for such problem statement variability. Further, conventional techniques are generally unable to ensure continued, up-to-date compliance with relevant labor laws, regulations, and union agreements, which frequently vary by location and industry. Consequently, conventional techniques often fail to avoid legal issues, fines, and negative impacts on the employee experience resulting from such non-compliance.

Accordingly, there is an opportunity for platforms and technologies to employ AI systems for forward looking scheduling/forecasting.

### SUMMARY

Broadly, the invention disclosed herein is an optimization toolkit (referenced herein as an “AI system”) for solving large optimization workforce management problems. This AI system may be and/or include modules, subsystems, and/or other components or combinations thereof configured to execute/perform several primary functions. For example, the AI systems disclosed herein may identify and define a workforce management problem including key components such as jobs, employees, skills, constraints (e.g., time-related constraints), and/or establishing objectives and requirements for the scheduling process. The AI systems disclosed herein may also collect and process demand data, including a forecasted number of jobs and the average handle time for each job/task. As part of processing the demand data, the AI systems may clean, preprocess, and/or transform the demand data to ensure quality and consistency for use in an optimization model.

Additionally, the AI systems disclosed herein may gather and process schedules data, such as employee availability, skills, and costs; and may align the schedules data with the demand data. Aligning the schedules data with the demand data may be or include the AI systems disclosed herein considering any constraints or preferences particular to a workforce, and/or creating a comprehensive dataset for the scheduling process. Thereafter, the AI systems disclosed herein may formulate optimization models using linear programming, integer programming, and/or any suitable constraint programming techniques or combinations thereof. In particular, the AI systems may incorporate the demand data and the schedules data, as well as any relevant constraints or objectives, into the optimization models and solve the optimization models using appropriate algorithms to generate customized, optimal schedules that meet operational demands and boost employee satisfaction and productivity.

Accordingly, the AI systems of the present disclosure represent a cutting-edge workforce management optimization tool that revolutionizes the way entities may pursue and overcome their scheduling challenges relative to conventional techniques. By meticulously analyzing and processing both demand data and schedules data, the AI systems of the present disclosure ensure that every aspect of a workforce management team's needs is considered, from employee skillsets to job requirements and scheduling constraints. Such comprehensive analysis was simply unachievable using conventional techniques, and as a result, the AI systems of the present disclosure improve over these conventional techniques for at least these reasons.

In an embodiment, a computer-implemented method of leveraging artificial intelligence for forward looking scheduling is provided. The computer-implemented method may comprise: receiving, at one or more processors, a set of demand data and a set of schedules data corresponding to a first period for a service provider; inputting, by the one or more processors, the set of demand data and the set of schedules data into an optimization model trained to generate optimal schedules based on a set of training demand data and a set of training schedules data; generating, by the one or more processors executing the optimization model, an optimal schedule for the first period based on the set of demand data and the set of schedules data; and outputting, by the one or more processors, the optimal schedule for display to a user associated with the service provider.

In a variation of this embodiment, the computer-implemented method may further comprise: receiving, at the one or more processors, a set of volume data and a set of average handle time data corresponding to a historical period for the service provider; and generating, by the one or more processors executing a demand model, the set of demand data based on the set of volume data and the set of average handle time data, wherein the set of demand data defines minimum supply requirements for the service provider during the first period. Further in this variation, the computer-implemented method may further comprise: filtering, by the one or more processors executing the demand model, the set of demand data by: (i) adding a shrinkage value to the set of demand data, (ii) applying a smoothing technique to peaks in the set of demand data exceeding a threshold value, (iii) redistributing demand volume based on a service level agreement (SLA), or (iv) loosening demand constraints at one or more intervals of the first period.

In another variation of this embodiment, the computer-implemented method may further comprise: receiving, at the one or more processors, a set of period constraints corresponding to the first period; and generating, by the one or more processors executing a scheduling model, one or more schedule templates based on the set of period constraints, wherein the set of schedules data comprises the one or more schedule templates. Further in this variation, the set of period constraints may comprise: (i) an allowable working days value, (ii) a shifts per week value, (iii) a permissible start times value, (iv) a start time allowed variance value, (v) a maximum unique start time value, (vi) a shift length value, (vii) a maximum unique shift length value, (viii) a non-permissible working hours value, (ix) a minimum weekly hours value, (x) a maximum weekly hours value, (xi) a maximum over time value, (xii) a maximum continuous days off value, or (xiii) a break time per shift value.

In yet another variation of this embodiment, generating the optimal schedule may further comprise: generating, by the one or more processors, a head count vector based on the set of demand data; generating, by the one or more processors, a schedules matrix based on the set of schedules data; and generating, by the one or more processors, the optimal schedule by multiplying the schedules matrix with the head count vector.

In still another variation of this embodiment, the optimal schedule may comprise a plurality of optimal schedules, and the computer-implemented method may further comprise: generating, by the one or more processors executing the optimization model, a set of personnel assignments for each schedule of the plurality of optimal schedules.

In yet another variation of this embodiment, the computer-implemented method may further comprise: generating, by the one or more processors executing the optimization model, a cost value corresponding to the optimal schedule.

In another embodiment, a system leveraging artificial intelligence (AI) for forward looking scheduling is provided. The system may comprise: a memory storing a set of computer-readable instructions including an optimization model; and one or more processors interfaced with the memory, and configured to execute the set of computer-readable instructions to cause the one or more processors to: receive a set of demand data and a set of schedules data corresponding to a first period for a service provider, input the set of demand data and the set of schedules data into an optimization model trained to generate optimal schedules based on a set of training demand data and a set of training schedules data, generate, by executing the optimization model, an optimal schedule for the first period based on the set of demand data and the set of schedules data, and output the optimal schedule for display to a user associated with the service provider.

In a variation of this embodiment, the computer-readable instructions, when executed, may further cause the one or more processors to: receive a set of volume data and a set of average handle time data corresponding to a historical period for the service provider; and generate, by executing a demand model, the set of demand data based on the set of volume data and the set of average handle time data, wherein the set of demand data defines minimum supply requirements for the service provider during the first period. Further in this variation, the computer-readable instructions, when executed, may further cause the one or more processors to: filter, by executing the demand model, the set of demand data by: (i) adding a shrinkage value to the set of demand data, (ii) applying a smoothing technique to peaks in the set of demand data exceeding a threshold value, (iii) redistributing demand volume based on a service level agreement (SLA), or (iv) loosening demand constraints at one or more intervals of the first period.

In another variation of this embodiment, the computer-readable instructions, when executed, may further cause the one or more processors to: receive a set of period constraints corresponding to the first period; and generate, by executing a scheduling model, one or more schedule templates based on the set of period constraints, wherein the set of schedules data comprises the one or more schedule templates. Further in this variation, the set of period constraints may comprise: (i) an allowable working days value, (ii) a shifts per week value, (iii) a permissible start times value, (iv) a start time allowed variance value, (v) a maximum unique start time value, (vi) a shift length value, (vii) a maximum unique shift length value, (viii) a non-permissible working hours value, (ix) a minimum weekly hours value, (x) a maximum weekly hours value, (xi) a maximum over time value, (xii) a maximum continuous days off value, or (xiii) a break time per shift value.

In yet another variation of this embodiment, the computer-readable instructions, when executed, may further cause the one or more processors to: generate a head count vector based on the set of demand data; generate a schedules matrix based on the set of schedules data; and generate the optimal schedule by multiplying the schedules matrix with the head count vector.

In still another variation of this embodiment, the optimal schedule may comprise a plurality of optimal schedules, and the computer-readable instructions, when executed, further cause the one or more processors to: generate, by executing the optimization model, a set of personnel assignments for each schedule of the plurality of optimal schedules.

In yet another embodiment, a non-transitory computer-readable storage medium configured to store instructions executable by one or more processors is disclosed. The instructions may comprise: instructions for receiving a set of demand data and a set of schedules data corresponding to a first period for a service provider; instructions for inputting the set of demand data and the set of schedules data into an optimization model trained to generate optimal schedules based on a set of training demand data and a set of training schedules data; instructions for generating, by executing the optimization model, an optimal schedule for the first period based on the set of demand data and the set of schedules data; and instructions for outputting the optimal schedule for display to a user associated with the service provider.

In a variation of this embodiment, the instructions may further comprise: instructions for receiving a set of volume data and a set of average handle time data corresponding to a historical period for the service provider; and instructions for generating, by executing a demand model, the set of demand data based on the set of volume data and the set of average handle time data, wherein the set of demand data defines minimum supply requirements for the service provider during the first period.

In another variation of this embodiment, the instructions may further comprise: instructions for filtering, by executing the demand model, the set of demand data by: (i) adding a shrinkage value to the set of demand data, (ii) applying a smoothing technique to peaks in the set of demand data exceeding a threshold value, (iii) redistributing demand volume based on a service level agreement (SLA), or (iv) loosening demand constraints at one or more intervals of the first period.

In yet another variation of this embodiment, the instructions may further comprise: instructions for receiving a set of period constraints corresponding to the first period; and instructions for generating, by executing a scheduling model, one or more schedule templates based on the set of period constraints, wherein the set of schedules data may comprise the one or more schedule templates, and wherein the set of period constraints may comprise: (i) an allowable working days value, (ii) a shifts per week value, (iii) a permissible start times value, (iv) a start time allowed variance value, (v) a maximum unique start time value, (vi) a shift length value, (vii) a maximum unique shift length value, (viii) a non-permissible working hours value, (ix) a minimum weekly hours value, (x) a maximum weekly hours value, (xi) a maximum over time value, (xii) a maximum continuous days off value, or (xiii) a break time per shift value.

In still another variation of this embodiment, the instructions may further comprise: instructions for generating a head count vector based on the set of demand data; instructions for generating a schedules matrix based on the set of schedules data; and instructions for generating the optimal schedule by multiplying the schedules matrix with the head count vector.

Thus, in accordance with the discussions herein, the present disclosure includes improvements to other technologies or technical fields at least because the present disclosure describes or introduces improvements in the field of workforce management. Namely, the optimization model executing on a user computing device or other computing devices (e.g., server) improves the field of workforce management by increasing the accuracy and comprehensiveness of work schedules in a manner that was previously unachievable using conventional techniques. This improves over conventional techniques at least because such techniques lack the ability to perform the accurate, efficient, and comprehensive forward looking schedule generation performed as a result of the instructions included in the optimization model, and are otherwise simply not capable of performing forward looking scheduling in a manner similar to the techniques of the present disclosure.

Moreover, the present disclosure includes effecting a transformation or reduction of a particular article to a different state or thing, e.g., transforming or reducing the forward looking scheduling of a workforce device/server from a non-optimal or error state to an optimal state by utilizing an optimization model to incorporate demand data and schedules data that results in optimal schedule generation through comprehensive workforce data inclusion.

Still further, the present disclosure includes specific features other than what is well-understood, routine, conventional activity in the field, or adding unconventional steps that demonstrate, in various embodiments, particular useful applications, e.g., inputting, by the one or more processors, the set of demand data and the set of schedules data into an optimization model trained to generate optimal schedules based on a set of training demand data and a set of training schedules data; and/or generating, by the one or more processors executing the optimization model, an optimal schedule for the first period based on the set of demand data and the set of schedules data, among others.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIG. 2 depicts a workflow overview associated with forward looking scheduling, in accordance with some embodiments.

FIG. 3A depicts a post-processing function with a rounding step associated with forward looking scheduling, in accordance with some embodiments.

FIG. 3B depicts an example personnel prediction and matching with an output optimized schedule, in accordance with some embodiments.

FIG. 4 depicts an exemplary graphical user interface (GUI) featuring an optimized schedule with corresponding available supply by time intervals, in accordance with some embodiments.

FIG. 5 is a block diagram illustrating an example method of leveraging artificial intelligence for forward looking scheduling, in accordance with some embodiments.

### DETAILED DESCRIPTION

The present embodiments may relate to, inter alia, leveraging artificial intelligence for forward looking scheduling. Generally, and as previously mentioned, the present disclosure provides a system and method for optimizing workforce asset scheduling in various workforce management scenarios, leading to significantly improved productivity for entities relative to the scheduling provided by conventional techniques. The systems disclosed herein may use an optimization model to generate an optimized set of schedules with a particular number of persons assigned that meets requirements (e.g., service level requirements) provided by a user while minimizing costs. The systems and methods disclosed herein may be described herein in the context of call centers, but this may be for the purposes of discussion only. In fact, the systems and methods described herein may apply to various industries that require scheduling, including but not limited to call centers, back-office operations, hospitals, etc.

As previously discussed, efficient employee/asset scheduling is crucial to the viability of various entities, as it can significantly impact their resulting performance. In todays dynamic environment, workforce scheduling problems have become increasingly complex due to multiple factors, such as changing demand patterns, employee preferences, and labor laws. The systems and methods of the present disclosure represent efficient and effective scheduling techniques that are configured to handle the complexity and variability of contemporary workforce management scenarios.

In particular, the systems and methods disclosed herein may provide/yield multiple advantages over conventional techniques. Namely, the present techniques may enhance productivity, optimize resource allocation/utilization, improve user/customer experiences and overall satisfaction, increase required compliance, provide data-driven recommendations, reduce costs, and generally provide schedules with greater efficiency and adaptability than was possible using conventional techniques. For example, the present techniques enable entities to allocate employees to tasks and projects that best/optimally align with their skills and expertise and also match with demand arrival patterns, thereby creating schedules that fulfill the required tasks/jobs in the most optimal manner possible.

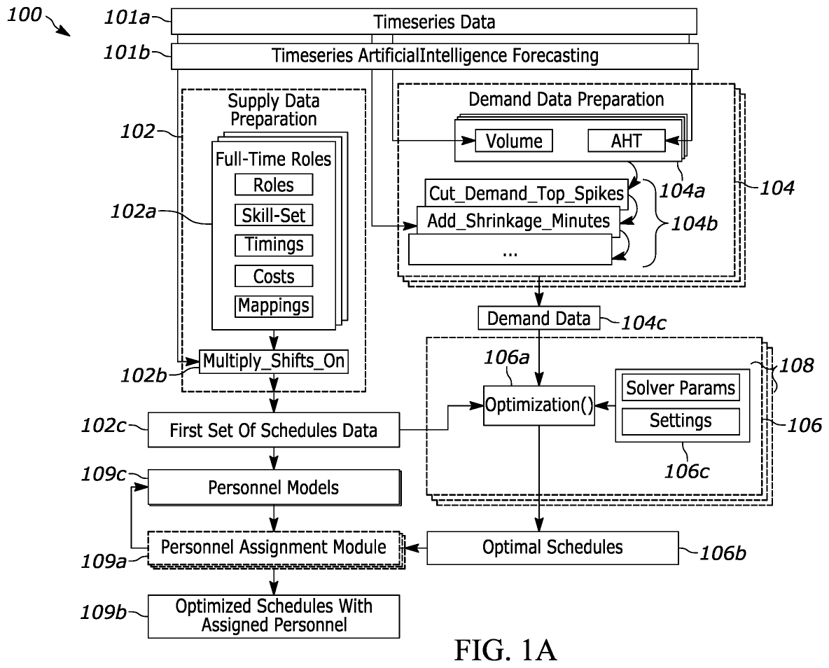

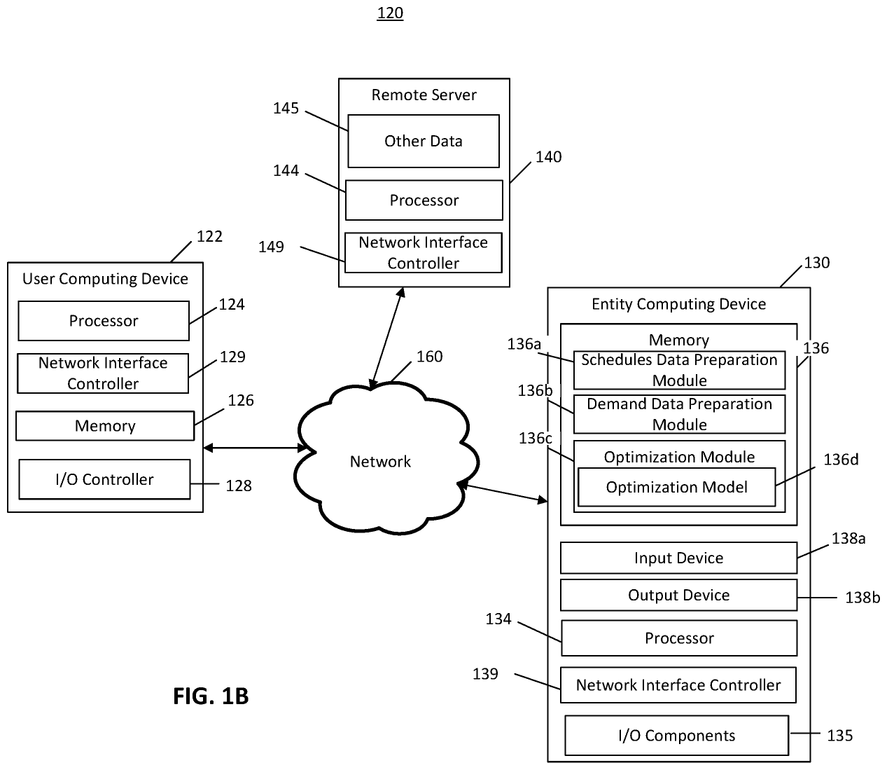

To achieve these advantages, the systems and methods of the present disclosure introduce a scheduling optimization pipeline configured to generate optimized schedules. This scheduling optimization pipeline generally involves collecting relevant data (e.g., demand data and schedules data), modeling the scheduling problem, and evaluating the optimal solution (e.g., an optimized schedule(s)). Such a scheduling optimization pipeline is broadly illustrated by the example system 100 of FIG. 1A. The example system 100 includes several modules 102, 104, 106 that may reflect the steps involved in the scheduling optimization pipeline necessary to optimize schedules for a particular entity. For example, these modules 102, 104, 106 may include a schedules data preparation module 102, a demand data preparation module 104, and an optimization module 106. The example system 100 may also include receiving timeseries data 101a and proceeding to perform timeseries AI forecasting 101b with such timeseries data 101a utilizing the modules 102, 104, 106. Moreover, when an optimized schedule 106b is output from the optimization module 106, the optimized schedule 106b may be further enhanced by the personnel assignment modules 109a, 109c configured to output the optimized schedules with assigned personnel 109b. Of course, it should be appreciated that the example system 100 is merely an example and that alternative or additional components are envisioned.

Each of the schedules data preparation module 102 and the demand data preparation module 104 may prepare data (e.g., demand data and/or schedules data) for input into the optimization module 106. The modules 102, 104 may generally gather the relevant data (e.g., scheduling data, demand data, timeseries data 101a, etc.), clean and/or otherwise prepare the data, and define/identify the inputs/constraints/conditions that must be satisfied (e.g., labor laws, employee availability, skill requirements, service level agreements) to attain certain optimization goals. The schedules data preparation module 102 and/or the demand data preparation module 104 may then gather the necessary data to model the scheduling optimization problem, such as employee information (e.g., availability, skills, preferences), the timeseries data 101a, historical workload data, forecasted demand, and/or other relevant information or combinations thereof. The results of this data gathering may be represented in the data clusters 102a, 104a.

With the data collected, the schedules data preparation module 102 and the demand data preparation module 104 may proceed to preprocess the data by cleaning the data, transforming the data, standardizing the data, handling missing values, converting data types, scaling values, and/or performing any other suitable processing or combinations thereof with and/or to the gathered data. For example, the schedules data preparation module 102 may transform the collected data represented in the cluster 102a by, for example, multiplying 102b portions of the collected data by the number of work shifts to be worked during the specified time period to generate the first set of schedules data 102c. As another example, the demand data preparation module 104 may add shrinkage minutes, cut demand spikes, and/or perform other preprocessing actions (e.g., as represented by the preprocessing actions 104b) on the data represented in the cluster 104a to generate the first set of demand data 104c. Further, the data gathered and/or preprocessed by the schedules data preparation module 102 may be referenced herein as “schedules data” and the data gathered and/or preprocessed by the demand data preparation module 104 may be referenced herein as “demand data”.

In any event, the schedules data preparation module 102 and the demand data preparation module 104 may transmit the demand data and the schedules data to the optimization module 106 where the data may be used as inputs to the optimization model 106a to output an optimized schedule 106b. Generally speaking, the optimization module 106 may receive and/or otherwise define objectives and constraints that outline the optimization goals (e.g., maximizing productivity) and formulate and/or otherwise train the optimization model 106a by developing/implementing a mathematical representation of the individual scheduling problem using an appropriate optimization technique, such as linear programming, integer programming, or constraint programming. This involves the optimization module 106 defining an objective function that outlines the optimization goals (e.g., maximizing productivity), and relevant constraints using the preprocessed data received from the schedules data preparation module 102 and the demand data preparation module 104.

The optimization module 106 may then use the particular optimization technique to solve the mathematical representation embodied in the optimization model 106a and generate an optimal solution (i.e., the optimal schedule 106b) that satisfies the constraints and meets the defined objectives. For example, the optimization module 106 may define and/or otherwise utilize a set of optimization parameters 106c that may include solver parameters, constraint settings, etc., and may apply these optimization parameters 106c to the optimization model 106a. In this manner, the optimization module 106 may also validate and analyze the results/outputs of the optimization model 106a (e.g., optimal schedule 106b) by checking the validity of the optimal schedule 106b to ensure that it meets all constraints and achieves the desired goals. The optimal schedule 106b may generally be or include a schedules list with a corresponding integer number of personnel assigned to manage and/or otherwise handle the tasks/jobs/shifts associated with the schedules. Further, in certain embodiments, the optimization module 106 may also analyze the optimal schedule 106b to gain insights into resource allocation, potential bottlenecks, areas for improvement, and/or any other information that may be used in subsequent problem/model formulation/optimization.

With the optimal schedules 106b generated, the system 100 may further include automatically assigning specific personnel to each of the tasks/jobs/shifts included as part of the optimal schedules 106b. Namely, the example system 100 may input the optimal schedules 106b into a personnel assignment module 109a configured to assign the specific personnel to the tasks/jobs/shifts included as part of the optimal schedules 106b. The personnel assignment module 109a may generally be or include any of the AI/ML components or systems described herein, such as the personnel matching block 208, and/or any other suitable components or combinations thereof, as described herein. The personnel assignment module 109a may generate the optimized schedules with assigned personnel 109b by applying any suitable personnel model(s) 109c corresponding to each individual personnel to the optimal schedules 106b. The personnel model(s) 109c may generally be models (e.g., AI/ML models) trained to output schedule preferences, task preferences, job preferences, shift preferences, and/or any other suitable preferences reflective of individual personnel based on the individual personnel's prior acceptance, performance, and/or other data corresponding to similar schedule(s), task(s), job(s), shift(s), etc. that the personnel may have accepted and/or performed. The personnel assignment module 109a may also automatically update, re-train, and/or otherwise modify these personnel models 109c based on the ultimate outcome of the optimized schedules with assigned personnel 109b. For example, if a first optimized schedule with assigned personnel results in a first individual not accepting an assigned shift, then the personnel assignment module 109a may update the first individual's model (e.g., as part of 109c) to more accurately predict scheduling assignments for the first individual in future iterations.

Further, the various modules 102, 104, 106 of the example system 100 may be configured to run and/or otherwise perform the relevant actions described herein in any suitable fashion, such as linearly and/or in parallel. For example, the optimization module 106 may be configured to concurrently run various/multiple optimization problems in different clusters (e.g., utilizing different sets of demand data and for different geographical regions and/or office locations/clusters simultaneously). The demand data preparation module 104 may similarly be configured to concurrently collect and prepare sets of demand data corresponding to different time periods 108 to more efficiently generate highly nuanced optimal schedules for time periods of any suitable granularity (e.g., minutes, hours, days, weeks, etc.). This parallel processing approach may significantly expedite the overall forward looking scheduling optimization solution represented by the example system 100, as the parallel processing paradigm may enable the example system 100 to handle multiple optimization scenarios more efficiently and effectively.

FIG. 1B depicts an overview of certain exemplary components 120 of the example system 100 of FIG. 1A that are configured to facilitate the systems and methods of the present disclosure, in accordance with some embodiments. It should be appreciated that the exemplary components 120 are merely exemplary and that alternative or additional components are envisioned.

As illustrated in FIG. 1B, the exemplary components 120 may include a set of electronic devices 122, 130, 140. Each of the electronic devices 122, 130, 140 may be any type of electronic device such as a mobile device (e.g., a smartphone), desktop computer, sever, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. In embodiments, any of the electronic devices 122, 130, 140 may be an electronic device associated with an individual or an entity such as a company, business, corporation, or the like (e.g., a server computer or machine).

The electronic devices 122, 130, 140 may communicate with the other electronic devices 122, 130, 140 via one or more networks 160. In some embodiments, the network(s) 160 may support any type of data communication via any standard or technology (e.g., GSM, CDMA, VOIP, TDMA, WCDMA, LTE, EDGE, OFDM, GPRS, EV-DO, UWB, Internet, IEEE 802 including Ethernet, WiMAX, Wi-Fi, Bluetooth, 4G/5G/6G, Edge, and others).

Components of the entity computing device 130 may include, but are not limited to, a processing unit (e.g., processor(s) 134), a system memory (e.g., memory 136), an input device 138a, an output device 138b, and a network interface controller (NIC) 139. In some embodiments, the processor(s) 134 may include one or more parallel processing units capable of processing data in parallel with one another. Although not shown, the processor(s) 134 and memory 136 may be connected via a system bus, which may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The output device 138b may be any device (e.g., a monitor) and/or interface configured to present content (e.g., input data, output data, processing data, and/or other information) for a user. Additionally, a user may review results of a schedule optimization analysis and make selections of/from the presented content via the input device 138a (e.g., a keyboard, touchscreen, microphone, mouse, trackball, touch pad, gesture sensor (camera), etc.), such as to review output data presented thereon, make selections, and/or perform other interactions. In addition to the monitor, the output device 138b may also include other peripheral output devices such as a printer, which may be connected through an output peripheral interface (not shown). Further, the entity computing device 130 may include various I/O components 135 (e.g., ports, capacitive or resistive touch sensitive input panels, keys, buttons, lights, LEDs, external or built-in keyboard).

The memory 136 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications, data structures, program modules (e.g., a schedules data preparation module 136a, a demand data preparation module 136b, an optimization module 136c), and/or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor(s) 134 of the entity computing device 130.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor(s) 134 (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML, R, Stata, AI libraries). In some embodiments, the computer program product may be part of a cloud network of resources.

In any event, the entity computing device 130 may be associated with an entity such as a company, business, corporation, or the like (generally, a company) that may be interested in forward looking scheduling optimization. The entity computing device 130 may include various components (e.g., network interface controller 139) that support and/or otherwise perform communication with the other electronic devices 122, 140. The user computing device 122 may be associated with an entity such as an individual (e.g., manager, administrator) who may be interested in and/or otherwise perform various actions related to forward looking scheduling optimization (e.g., input constraints, goals, etc.). The user computing device 122 may also include various components (e.g., processor 124, memory 126, input/output (I/O) controller 128, network interface controller 129) that support, enable, and/or otherwise perform communications with the other electronic devices 130, 140. Further, the remote server 140 may be any suitable cluster, cloud-based, and/or otherwise configured server that, in certain embodiments, may be configured to participate in actions/functions associated with forward looking scheduling optimization. The remote server 140 may also include various components (e.g., processor 144, other data 145, network interface controller 149) that support, enable, and/or otherwise perform communications with the other electronic devices 122, 130.

Accordingly, the entity computing device 130 may communicate with one or more of the user computing device 122 and/or the remote server 140 to compile, store, or otherwise access information associated with forward looking scheduling optimization. In some implementations, the entity computing device 130 may access the raw data or information from one or more of the electronic devices 122, 140 and/or the entity computing device 130 may access such relevant data from memory 136. The entity computing device 130 may analyze this data according to the functionalities as described herein, which may result in a set of optimized schedules. More specifically, the entity computing device 130 may collect, prepare, and analyze sets of schedules data and/or sets of demand data using the schedules data preparation module 136a, the demand data preparation module 136b, and the optimization module 136c.

According to embodiments, the entity computing device 130 may implement an artificial intelligence-based analysis technique(s) to the analyze the sets of schedules data and/or the sets of demand data. For example, the entity computing device 130 may formulate optimization models (e.g., optimization model 136d) through the optimization module 136c using linear programming, integer programming, and/or any suitable constraint programming techniques or combinations thereof. In these examples, the entity computing device 130 may execute the schedules data preparation module 136a to generate sets of schedules data and execute the demand data preparation module 136b to generate sets of demand data, and the device 130 may generate and utilize an AI-based optimization model 136d by executing optimization module 136c to output optimized schedule(s).

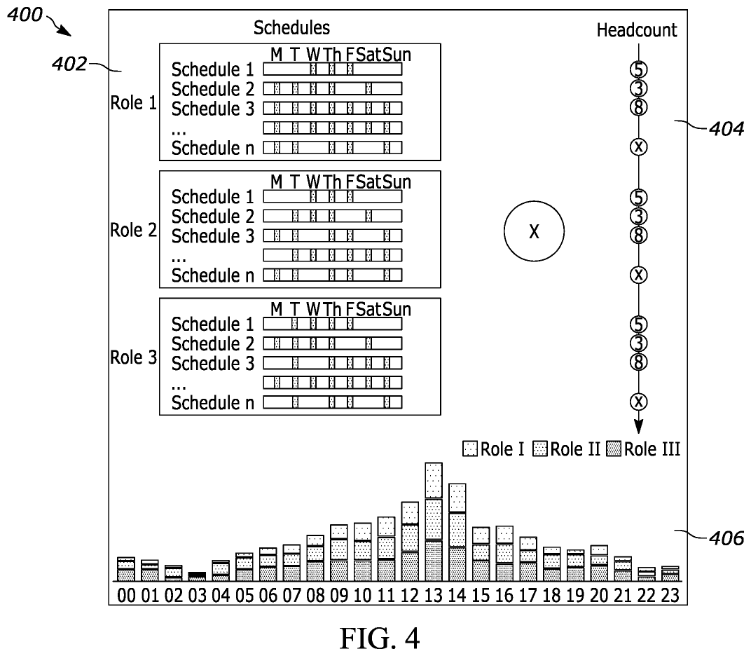

The entity computing device 130 (or another component) may cause the outputs from the optimization module 136c (and, in some cases, the training or input data) to be displayed on the output device 138b for review by the user. Additionally, the optimization module 136c and/or other suitable component(s) may cause the outputs from the optimization model 136d to be displayed in a graphical user interface (GUI), as described herein in reference to FIG. 4. The user may interact with the input device 138a, for example, to review and/or modify the displayed data. For instance, the user may review the output optimized schedules to assess opportunities for improving workforce asset allocation and general operations.

Further, in certain embodiments, the entity computing device 130 may also utilize machine learning (ML) as part of executing the optimization module 136c to generate the optimal schedule(s). In particular, the entity computing device 130 may train and test one or more machine learning models with a set of training schedules data and/or a set of training demand data (e.g., model input data and scheduling constraints) to generate optimal schedule(s) as output. A user of the user computing device 122 and/or who otherwise has access to the entity computing device 130 (e.g., an individual performing forward looking scheduling optimization) may review the result(s) or output(s) and use the information for various purposes. In certain embodiments, a user may access the result(s) or output(s) directly from the entity computing device 130.

Generally speaking, ML techniques have been developed that allow parametric or nonparametric statistical analysis of large quantities of data. Such ML techniques may be used to automatically identify relevant variables (i.e., variables having statistical significance or a sufficient degree of explanatory power) from data sets. This may include identifying relevant variables or estimating the effect of such variables that indicate actual observations in the data set. This may also include identifying latent variables not directly observed in the data, viz. variables inferred from the observed data points. More specifically, a processor or a processing element may be trained using supervised or unsupervised ML.

In supervised machine learning, a machine learning program operating on a server, computing device, or otherwise processors, may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on a server, computing device, or otherwise processors as described herein, to predict or classify, based upon the discovered rules, relationships, or model, an expected output, score, or value.

In unsupervised machine learning, the server, computing device, or otherwise processors, may be required to find its own structure in unlabeled example inputs, where, for example multiple training iterations are executed by the server, computing device, or otherwise processors to train multiple generations of models until a satisfactory model, e.g., a model that provides sufficient prediction accuracy when given test level or production level data or inputs, is generated.

Exemplary ML programs/algorithms that may be utilized by the entity computing device 130 to train the optimization model 136d as part of the optimization module 136c may include, without limitation: neural networks (NN) (e.g., convolutional neural networks (CNN), deep learning neural networks (DNN), combined learning module or program), linear regression, logistic regression, decision trees, support vector machines (SVM), naïve Bayes algorithms, k-nearest neighbor (KNN) algorithms, random forest algorithms, gradient boosting algorithms, Bayesian program learning (BPL), voice recognition and synthesis algorithms, image or object recognition, optical character recognition (OCR), natural language understanding (NLU), and/or other ML programs/algorithms either individually or in combination.

After training, ML programs (or information generated by such ML programs) may be used to evaluate additional data. Such data may be and/or may be related to demand data and/or other data that was not included in the training dataset. The trained ML programs (or programs utilizing models, parameters, or other data produced through the training process) may accordingly be used for determining, assessing, analyzing, predicting, estimating, evaluating, or otherwise processing new data not included in the training dataset. Such trained ML programs may, therefore, be used to perform part or all of the analytical functions of the methods described elsewhere herein.

It is to be understood that supervised ML and/or unsupervised ML may also comprise retraining, relearning, or otherwise updating models with new, or different, information, which may include information received, ingested, generated, or otherwise used over time. The disclosures herein may use one or more of such supervised and/or unsupervised ML techniques. Further, it should be appreciated that, as previously mentioned, the optimization model 136d included as part of and/or otherwise generated by the optimization module 136c may be used to output an optimal schedule(s) using optimization techniques (e.g., linear programming, integer programming, etc.) or, in alternative aspects, without using artificial intelligence.

Moreover, although the methods described elsewhere herein may not directly mention ML techniques, such methods may be read to include such ML for any determination or processing of data that may be accomplished using such techniques. In some aspects, such ML techniques may be implemented automatically upon occurrence of certain events or upon certain conditions being met. In any event, use of ML techniques, as described herein, may begin with training a ML program, or such techniques may begin with a previously trained ML program.

In any event, the entity computing device 130 may be configured to interface with or support a memory or storage 136 capable of storing various data, such as in one or more databases or other forms of storage. According to embodiments, the storage 136 may store data or information associated with the AI models that are generated and used by the entity computing device 130. Additionally, the entity computing device 130 may access the data associated with the stored AI models to input a set of inputs into the AI models.

Although depicted as a single entity computing device 130 in FIG. 1B, it should be appreciated that the entity computing device 130 may be in the form of a distributed cluster of computers, servers, machines, cloud-based services, or the like. Namely, and in certain embodiments, the entity computing device 130 may perform the functionalities as discussed herein as part of a “cloud” network or may otherwise communicate with other hardware or software components within the cloud to send, retrieve, or otherwise analyze data. In such embodiments, the entity may utilize the entity computing device(s) 130 as part of an on-demand cloud computing platform. Accordingly, when the electronic devices 122, 140 interface with the entity computing device 130, the electronic devices 122, 140 may actually interface with one or more of a number of distributed computers, servers, machines, or the like, to facilitate the described functionalities.

Although three (3) electronic devices 122, 130, 140 are depicted in FIG. 1B, it should be appreciated that greater or fewer amounts are envisioned. For example, there may be multiple server computers, each one associated with a different entity. Moreover, while described herein as executing on the entity computing device 130, it should be appreciated that the actions described herein with respect to the schedules data preparation module 136a, the demand data preparation module 136b, and/or the optimization module 136c may be performed, in whole or in part, on any suitable component that is communicatively coupled with the entity computing device 130.

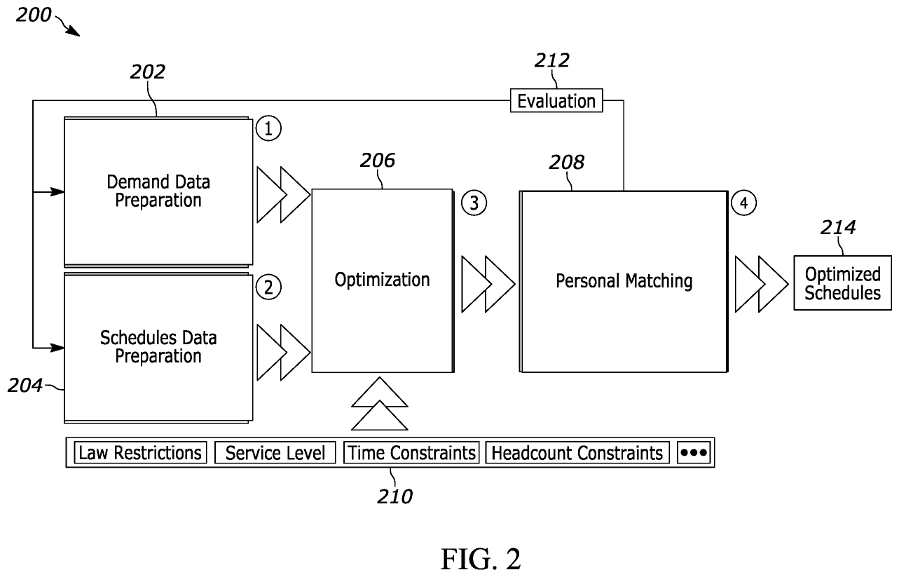

FIG. 2 illustrates a workflow overview 200 associated with forward looking scheduling, in accordance with some embodiments. The features and functionalities as illustrated in FIG. 2 may be performed by a computing device(s), such as the entity computing device 130, the user computing device 122, and/or the remote server 140, as discussed with respect to FIG. 1B. Generally speaking, the workflow overview 200 includes three stages: data preparation (202, 204), schedule optimization (206), and personnel matching (208).

In the data preparation (202, 204) stages, the problem may be identified and defined by considering specific industry and company restrictions that must be respected/fulfilled in the final optimized schedules 214. Thus, the data preparation (202, 204) stages include consideration of various factors to ensure that the generated optimized schedules 214 effectively allocate resources, maximize productivity, and minimize costs while adhering to relevant constraints. These factors may include: forecasted demand data (“demand data”), constraints and service level agreements, skill-based routing, shift constraints, and/or other suitable factors or combinations thereof. These factors may be provided by a user (e.g., utilizing user computing device 122) and/or may be retrieved from memory (e.g., memory 136).

The forecasted demand data may be considered at the demand data preparation stage 202 and may correspond to defining a scope of demand filters and/or considering aspects such as time-series frequency, entropy, and seasonality. Understanding these demand characteristics helps the optimization model (e.g., optimization model 136d) to accurately model the demand and match it with the workforce supply.

The constraints and service level agreements may generally reflect varying service level requirements depending on the specific use-case. For example, call centers typically have a lower average answer speed than back-office operations, which may necessitate different service levels. As another example, while many industries may aim for approximately 100% demand fulfillment, hospitals and/or other medical service providers might prefer to overstaff rather than prioritize high utilization to ensure adequate levels of service availability. Additionally, or alternatively, the constrains and service level agreements may be or include a total available personnel value, thereby ensuring that the optimized schedule(s) 214 does not exceed the total workforce capacity.

The skill-based routing data may generally correspond to skills, certifications, and/or other particular abilities that certain personnel may have that may qualify those personnel for specific jobs/tasks. Of course, assigning personnel with specialized skills to handle specific tasks or customers may be essential in many industries. Thus, the computing device (e.g., entity computing device 130) may utilize this skill-based routing data to identify mutually exclusive clusters of schedules, personnel, etc. that may allow for parallel schedule optimization. For example, if two call center queues may be staffed by the same personnel, the entity computing device 130 may be unable to optimize the schedules in parallel. However, if the queues are always served by different personnel, then the entity computing device 130 may be able to split these two schedule optimization tasks into two separate optimization problems.

The shift constraints data generally indicates the particular constraints an entity and/or a broader industry may be required to (e.g., by law) and/or otherwise may place on the shifts workable by any particular personnel or group(s) of personnel. In other words, the entity computing device 130 must ultimately generate the optimized schedules 214 that are in compliance with labor laws, such as maximum work hours and mandatory breaks. Additionally, or alternatively, the shift constraints data may be or include indications related to whether the workforce is distributed across different time zones, and may allow the entity computing device 130 to consider their geographical location and adjust all schedules to a common time reference, such as UTC.

Thus, by carefully addressing each of these factors in the beginning of the data preparation stages (202, 204), the optimization block 206 and the personnel matching block 208 may generate tailored, optimized schedules 214 that meet the unique requirements and constraints of each entity and industry.

More specifically, the demand data preparation block 202 includes the entity computing device 130 preparing a demand time series dataset based on an average handle time (AHT) and an amount of jobs (e.g., volume) for a particular entity during a specified time period, over which, the entity desires to have an optimized schedule (e.g., optimized schedules 214). The outputs from the demand data preparation block 202 may enable the entity computing device 130 to estimate future workloads and allocate resources efficiently at the subsequent optimization 260 and/or personnel matching 208 blocks.

As an initial step, the entity computing device 130 may stack the demand data by organizing the aggregated demand information based on the AHT for the entity and considering unfulfilled demand from any previous time intervals. More specifically, the entity computing device 130 may calculate the demand for each minute interval within the specified time period by considering both the demand within the current time interval and any carry-over demand from previous time intervals. The formula utilized by the entity computing device 130 (e.g., the demand data preparation module 136b) for calculating the demand per minute interval may be expressed as follows:

$$D ( t ) = v ( t ) * min ( aht ( t ) , mi ) + {\sum }_{k = st}^{k < t} v ( t - k ) * ( aht ( t - k ) - k * mi ) \qquad ( 1 )$$

where t may be an identificatory representing the given point in time, v(t) may be a forecasted number of jobs arriving at each point in time, ah(t) may be a forecasted AHT or duration of jobs arriving at each point of time, mi may be a minutes interval for a particular use-case, st may be a start time of data being processed, and D(t) may be the calculated demand at each point of time.

By applying equation (1), the entity computing device 130 may calculate the demand for each minute interval, considering both the demand within the current time interval and any carry-over demand from previous time intervals. The resulting stacked demand data may have observations ordered by job type and stage, and may thereby allow the entity computing device 130 to generate optimized schedules 214 with a more optimized resource allocation and based on a more accurate representation of workforce requirements than was possible using conventional techniques.

However, prior to utilizing the stacked demand data for forward looking schedule optimization, the entity computing device 130 may additionally filter the demand data to ensure the demand data accurately represents the workforce requirements. In particular, the entity computing device 130 may filter the demand data to remove any anomalies, such as outliers or noise, that may negatively impact the optimization process. Thus, by filtering the demand data, the entity computing device 130 may improve the quality of the demand data ultimately input into the optimization model 136d, which in turn may lead to more accurate and effective scheduling decisions.

One exemplary filtering technique involves the entity computing device 130 smoothing top spikes within the demand data. This exemplary filtering technique enables the entity computing device 130 to eliminate spikes in the demand data that may appear abnormal and/or are known to be natural but not necessarily significant for the schedule optimization process performed by the entity computing device 130. Namely, smoothing the top spikes of the demand data may be or include the entity computing device 130 identifying spikes within the demand data by examining neighboring data points of individual points within the demand data. By calculating the average difference between a data point within the demand data and its neighbors and comparing these difference values with those of other points, the entity computing device 130 may accurately and reliably pinpoint the spikes within the demand data. For example, the entity computing device 130 may determine spike locations within the demand data in accordance with the following equation:

$$s ( t ) = \frac{( d ( t ) - d ( t - 1 ) ) + ( d ( t ) - d ( t + 1 ) )}{2} \qquad ( 2 )$$

where d(t) may be the calculated demand at each point of time, d(t−1) may be the calculated demand at the previous point of time, d (t+1) may be the calculated demand at the next (or a subsequent) point of time, and s(t) may be a calculated spike at each point of time.

As mentioned, in equation (2), s(t) may represent the potential spike at data point i. If s(t) for a first data point within the demand data is significantly larger than the average differences between neighboring points in the demand data, the entity computing device 130 may determine the first data point represents a spike. To determine whether the calculated s(t) for a first data point is significant enough to be considered a spike, the entity computing device 130 may compare the s(t) for the first data point with a predefined threshold and/or may use a statistical test to assess the significance of the s(t) for the first data point relative to the s(t) for the rest of the demand data. For example, the entity computing device 130 may evaluate whether an s(t) value for a first data point within the demand data is within an X quantile for all spikes across the timeline.

In an example, the entity computing device 130 may evaluate equation (2) for each point within a set of demand data and determine that a first data point is a spike. In this example, the entity computing device 130 may adjust this first data point to the level of a first threshold. The first threshold may be any suitable value, such as the 90th percentile, wherein the entity computing device 130 may remove any spikes present within the set of demand data that meet or exceed the 90th percentile value of demand within the set of demand data.

Another exemplary filtering technique includes the entity computing device 130 adding shrinkage minutes to the demand data. Typically, in many use-cases, the entity computing device 130 may determine the number of shrinkage minutes for a specific timestamp using historical data related to added shrinkage minutes. Generally speaking, shrinkage minutes refer to unproductive time allocated for non-work-related activities, such as meetings, unplanned breaks, and the like. To account for these activities, the entity computing device 130 may add them directly to the demand data in accordance with the following equation:

$${d}^{′} ( t ) = d ( t ) + S r ( t ) \qquad ( 3 )$$

where d(t) may be the calculated demand at each point of time, Sr(t) may be the forecasted shrinkage value at each point of time, and d′(t) may be the adjusted demand at each point of time. The entity computing device 130 incorporating this adjustment represented in equation (3) ensures that the resulting optimized schedules 214 may adequately account for shrinkage, and thereby reduce the risk of understaffing at any point in time.

A third exemplary filtering techniques includes the entity computing device 130 adjusting the demand data based on a long average speed to answer value. In certain use-cases with a long average speed to answer, ensuring adherence to various service level agreements (SLAs) may be challenging. To guarantee that all such requirements from SLAs are respected, the entity computing device 130 may employ a linear programming solution and/or any other suitable algorithmic technique to adjust the demand data. The entity computing device 130 may utilize this linear programming solution to determine the optimal time for addressing demand based on the SLAs outlining how long a job/task may wait in the queue.

For example, a first SLA may include requirements specifying: 0% of jobs must be addressed within an hour of their arrival, 50% of jobs must be addressed within 2 hours of arrival, 70% of jobs must be addressed within 5 hours of arrival, 80% of jobs must be addressed within 10 hours of arrival, and/or all jobs must be completed within 21 hours of arrival. Of course, it should be appreciated that the number of thresholds set for each job type may vary, such that a first job type may have only one threshold and no maximum limit required and a second job type may have ten thresholds with a maximum limit.

The entity computing device 130 may employ this smoothing technique via a linear program optimization algorithm to ascertain the optimal time for handling demand. Such an algorithm may generally be a two-step process: determining a supply probability curve representing the likelihood that schedules will be staffed at each time period, and smoothing demand by applying linear programming. The entity computing device 130 may apply the linear programming algorithm to shift the volume as closely as possible to the shape of the supply probability curve, subject to the constraints of the thresholds set by the SLA, which are discussed above.

To create the supply probability curve, the entity computing device 130 may consider several parameters, such as the number of possible schedules at a given point in time and the AHTs. In particular, the number of possible schedules at a given point in time may be weighted based on the cost of the schedule and potential personnel count to be assigned, according to the maximum available personnel count for that schedule assignment. The AHTs may be analyzed by the entity computing device 130 because time periods with longer AHTs may necessitate more personnel to meet the same demand. Consequently, the entity computing device 130 may scale the probabilities of available personnel by multiplying probabilities by the AHT of the jobs the roles for those schedules can handle. Moreover, in certain embodiments, the entity computing device 130 may evaluate the AHTs as individual AHTs or a subset of individual personnel AHTs to generate a more granular analysis of the personnel required to meet demand based on each individual's ability and availability to handle particular tasks/jobs during certain periods of time.

Thereafter, the entity computing device 130 may achieve smoothing the demand data, for example, using a linear program formulated with the following components: an objective function and relevant constraints. The objective function may generally involve the entity computing device 130 minimizing a difference between the slope of the smoothed demand curve and the slope of the supply probability curve at all points in time. The constraints may be or include requirements that the total volume of the smoothed demand curve must equal that of the original demand curve, the volume of the smoothed demand curve at all points in time must be less than the maximum volume across all times in the original demand curve, the percentage of volume shifted any number of periods out cannot be greater than those specified in the SLA parameters, and/or any other suitable requirements or combinations thereof.

In certain embodiments, this third exemplary filtering technique for addressing adherence to service level agreements (SLAs) may be adapted as a multi-objective linear programming solution. This approach may enable the entity computing device 130 to balance multiple objectives while optimizing demand handling based on SLA constraints. Thus, this multi-objective linear programming solution may provide an effective means to address workforce scheduling challenges, particularly in use-cases with long average speed to answer. Moreover, this third exemplary filtering technique may enable the entity computing technique 130 to make the schedule optimization multi-objective.

The schedules data preparation block 204 involves the entity computing device 130 collecting and organizing information on the available workforce (personnel), including their availability, skills, costs, and/or other constraints. As a result of the actions performed in the schedules data preparation block 204, the entity computing device 130 may obtain all possible schedule configurations for any suitable scheduling period (e.g., one week), such that the device 130 may (at the optimization block 206 and/or the personnel block 208) assign personnel to these schedules. The steps generally involved in preparing the schedules data may be and/or include the following: defining roles, collecting time-related constraints, defining roles skills, determining labor costs, and/or any other suitable steps/actions or combinations thereof.

More specifically, each of these steps performed by the entity computing device 130 as part of the schedules data preparation block 204 may include specific functions. For example, the entity computing device 130 may define roles to categorize different subsets of possible schedules and skillsets for distinct demand types. The entity computing device 130 may collect time-related constraints by gathering data on roles available working hours, days of the week, and/or other relevant factors. The entity computing device 130 may utilize this data to create a pool of potential schedules for each role. Further, the entity computing device 130 may define roles skills by identifying the skills required for each job type and mapping them among the different roles. This roles skill definition may be essential for the entity computing device 130 implementing skill-based routing and ensuring that the right personnel are assigned to the appropriate tasks. Still further, the entity computing device 130 may determine labor costs by gathering information on role wages, including hourly rates, overtime rates, and/or any additional costs (e.g., benefits, cost premiums). The entity computing device 130 may utilize this data to minimize labor costs while generating optimized schedules 214.

After identifying these data points, the entity computing device 130 may generate potential schedules. Namely, the entity computing device 130 may create a set of feasible schedules for each role based on their availability, skills, and/or constraints. The entity computing device 130 may utilize this set of feasible schedules as input for the optimization block 206 to generate an optimal workforce schedule 214.

As mentioned, the entity computing device 130 may define roles as part of the schedules data preparation block 204, as such role definition helps categorize different subsets of possible schedules and skillsets for distinct demand types. In particular, the entity computing device 130 may define roles by identifying hob types and functions, analyzing required skills and competencies, and/or defining separate roles with different time-related constraints.

The entity computing device 130 may identify job types and functions by listing all the job types and functions within an organization or a specific department of an entity/organization. For example, these job types may include customer service representatives, back-office staff, nurses, and/or any other roles relevant to a particular entity and/or industry. The entity computing device 130 may then determine the necessary skills and competencies that personnel should possess for the particular job types. These skills may be or include technical skills, soft skills, language proficiency, certifications, and/or any other qualifications that may be essential to perform the job type effectively. The entity computing device 130 may then make separate roles with different time-related constraints. For example, the entity computing device 130 may separate personnel that work night hours vs daily hours into two different roles. Thus, by following these steps, the entity computing device 130 may define roles effectively and lay the foundation for an efficient and optimized workforce scheduling process.

The entity computing device 130 may then collect time-related constraints. When preparing schedules data and creating potential schedules, the entity computing device 130 may consider various time-related constraints that may impact the workforce management process. For example, these constraints may be or include: (1) days of the week, (2) shifts per week, (3) start times, (4) shift lengths, (5) minimum continuous days off, (6) non-permissible working hours, (7) break hours per shift, (8) minimum and maximum weekly hours, (9) maximum overtime hours, and/or any other suitable values or combinations thereof.

More specifically, the time-related constraints may also include additional data. The entity computing device 130 may determine the days of the week by defining which weekday shifts may be allocated, such as “0, 1, 2, 5”, representing Monday, Tuesday, Wednesday, and Saturday. The entity computing device 130 may define the shifts per week as the number of shifts personnel are expected to work in a week. The entity computing device 130 may determine the start times based on a list of possible shift start times in a 24-hour format, such as “11, 12, 13, and 14”. The entity computing device 130 may determine the shift lengths based on a list of permissible shift lengths in hours, for example, “7, 8, 9”. The entity computing device 130 may determine the minimum continuous days off based on the minimum number of consecutive days that personnel must have off during a week. The entity computing device 130 may determine the non-permissible working hours based on time intervals during which employees are not allowed to work, such as “(3, 9), (21, 23)”. The entity computing device 130 may determine the break hours per shift based on specific hours during a shift when personnel cannot and/or may not work, often representing lunch breaks or meeting times, such as “12, 13, and 14” and/or meeting periods/times to reserve in hours and/or other suitable units, e.g., “0.5, 1, 1.5”. The entity computing device 130 may determine the minimum and maximum weekly hours based on the minimum number of hours individual personnel must work in a week and the maximum number of hours the individual personnel can work in a week to ensure a balanced workload. The entity computing device 130 may determine the maximum overtime hours based on the maximum number of hours personnel may work overtime, thereby helping to control labor costs and employee well-being.

By considering these time-related constraints, the entity computing device 130 may generate optimized schedules 214 that respect employee availability, legal requirements, and company policies. In this manner, the optimized schedules 214 output by the entity computing device 130 may ensure efficient and effective operations.

In any event, to create a set of all possible schedules given a list of parameters, the entity computing device 130 may need to consider all possible combinations of these parameters. These parameters may include days of the week, start times, shift lengths, and/or any other suitable parameters or combinations thereof. In certain embodiments, the total number of possible schedules may be represented as follows:

$$schedules = C ( DoW , SpW ) * {st}^{SpW} * {sl}^{SpW} \qquad ( 4 )$$

where DoW may be the days of the week, SpW may be the shifts per week, C(DoW, SpW) may be the combinations formula for the two first variables, st may be the start times, s/may be the shift length, and schedules may be all combinations of possible schedules.

The entity computing device 130 may continue by defining roles skills. As discussed herein, a “role” may be a group of skills and time-related information, such that roles may be differentiated based on shift constraints and skillsets. Namely, shift constraints may define the set of possible schedule configurations that may be selected by the entity computing device 130 when generating an optimal schedule 214, and the skillsets may define the set of job types to which the entity computing device 130 may assign a role. In certain instances, it may be more practical for the entity computing device 130 to assign multiple skills to a single role, thereby enabling these roles to handle different types of jobs (i.e., cross-skilling). For instance, a customer service representative at a bank may possess the skills to both open and close bank accounts, and/or a nurse in the emergency department may be capable of drawing a patients blood and cleaning wounds.

The entity computing device 130 may then determine labor costs. Such labor costs may be an essential aspect of workforce scheduling, as different rates and multipliers may apply to various work situations. These costs may be influenced by any number of factors, such as: night intervals, base costs, overtime cost multipliers, weekend cost multipliers, night cost multipliers, and/or any other suitable factors or combinations thereof.

More specifically, the entity computing device 130 may utilize such labor costs by determining and/or applying these factors in specific fashions. For example, the entity computing device 130 may determine night intervals based on defined periods considered as nighttime, during which higher costs may apply. These night intervals may be specified as time ranges, such as (22, 6), indicating that nighttime hours are from 10 PM to 6 AM. The entity computing device 130 may determine base costs based on a standard hourly rate for a given role during regular working hours. The entity computing device 130 may apply an overtime cost multiplier to the base cost when a particular personnel works beyond their regular hours, resulting in higher labor costs for overtime work. The entity computing device 130 may apply a weekend cost multiplier to the base cost when a particular personnel works on weekends, reflecting the increased labor costs associated with weekend work. The entity computing device 130 may also apply a night cost multiplier to the base cost for work performed during nighttime hours, accounting for the higher labor costs associated with nighttime work.

Thus, by considering these factors, the entity computing device 130 may accurately estimate labor costs and generate optimal workforce schedules 214 that balance employee availability, skills, and cost efficiency.

The optimization block 206 may include the entity computing device 130 utilizing the calculated and filtered demand data and the prepared schedules data to construct the optimization model (e.g., optimization model 136d). In particular, the actions performed as part of the optimization block 206 may be or include the following: extracting decision variables, determining supply requirements, establishing personnel count constraints, formulating an objective function, rounding optimization results, and/or any other suitable actions or combinations thereof.

The entity computing device 130 may begin by extracting the decision variables related to various schedule configurations. Namely, the set of decision variables may comprise most/all possible schedule configurations identified during the schedules data preparation block 204. As an example, a first decision variable may be an amount of personnel assigned to a single schedule from a given set. Typically, each decision variable may be an integer value and may generally not be less than zero.

Further, the entity computing device 130 may determine supply requirements. In certain embodiments, the entity computing device 130 may utilize the demand data from the demand data preparation block 202 when, for example, the entity computing device 130 uses default optimization. However, if the entity computing device 130 analyzes service level-related constraints for short ASA values, the entity computing device 130 may calculate the corresponding supply requirements using the Erlang C formula.

The entity computing device 130 may also establish personnel count constraints. Generally, such personnel count constraints may ensure that the total number of personnel assigned to particular schedules does not exceed the total available workforce. Thereafter, the entity computing device 130 may formulate an objective function that is configured to optimize a particular goal, such as maximizing employee utilization or minimizing labor costs. Additionally, in certain embodiments, the entity computing device 130 may proceed to round the optimization results. In these embodiments, the entity computing device 130 may need to round the results to ensure that the final optimized schedules 214 adhere to practical constraints, such as a whole number of personnel assigned to each schedule.

The entity computing device 130 may then proceed to determine supply requirements. The primary constraint for scheduling optimization may be that the supply at any given point in time must be greater than or equal to the demand. The entity computing device 130 may account for such a primary constraint in mathematical terms expressed using the following formula:

$$∀ h , r f ( Nhl , r ) \geq ∀ h , r {\sum }_{e = 1}^{E} g ( neh , r ) \qquad ( 5 )$$

where f(Nh, r) may be a supply function which returns a number of agents of role r available by taking Nhl (i.e. number of an agent of role r starting at time h with shift length l) and agent role r, and (h,r) may be the supply requirements function which returns the number of hours for role r at time h. The entity computing device 130 may utilize equation (5) to account for different types of demand types by using variable e. Further, neh may denote the number of demands of type e at hour h.

By default, the entity computing device 130 may assign (h,r) as the demand value at any given point in time. In fact, for use-cases with relatively long Average Speed of Answer (ASA) and AHT, this approximation may be sufficiently accurate. However, for use-cases with relatively short ASA, such as call centers, the entity computing device 130 may calculate the supply requirements using the Erlang C formula, reproduced below:

$${P}_{w} = \frac{\frac{{A}^{N}}{N !} * \frac{N}{N - A}}{( {\sum }_{i = 0}^{N - 1} \frac{{A}^{i}}{I !} ) + \frac{{A}^{N}}{N !} * \frac{N}{N - A}} \qquad ( 6 )$$

where A may be the traffic intensity (demand) or the length of time that all jobs would take if ordered end to end, N may be the number of personnel (e.g., agents) assigned to process a given traffic intensity, and Pw may be the probability that a job waits, given the traffic intensity and the number of personnel available.

By employing the Erlang C formula of equation (6), the entity computing device 130 may calculate the ASA using the following equation:

$$ASA ( t ) = \frac{{P}_{w} ( t ) * aht ( t )}{N ( t ) - A ( t )} \qquad ( 7 )$$

where aht(t) may be the forecasted average handle time or duration of jobs, which arrived at each point of time. Additionally, the entity computing device 130 may determine an SLA using the following alternative equation:

$$SL ( t ) = 1 - [ {P}_{w} ( t ) * {e}^{- [ ( N - A ) * ( \frac{tt}{aht ( t )} ) ]} ] \qquad ( 8 )$$

where tt may be the target answer time in which the entity computing device 130 may achieve the calculated percentage of service level.

By considering service level and ASA requirements, the supply requirements may correspondingly increase, thereby ensuring that these essential variables are appropriately addressed throughout the optimization block 206. Thus, this comprehensive approach allows the entity computing device 130 to perform more accurate and effective scheduling than conventional techniques that failed to consider such service level and ASA requirements. Ultimately, the entity computing device 130 may perform forward looking scheduling that improves overall performance and efficiency for associated entities.

The entity computing device 130 may then proceed as part of the optimization block 206 to formulate the objective function of the optimization model 136d. Generally, the objective function may serve as the foundation for the optimization model 136d by defining the goal that the model 136d is configured to achieve. In workforce scheduling optimization, the objective function may typically strive to minimize or maximize a particular aspect of the scheduling process, such as maximizing overall efficiency and/or minimizing labor costs. By specifying the desired outcome, the entity computing device 130 may formulate an objective function that helps guide the optimization process towards the most suitable solution (e.g., optimized schedules 214). As an example, the entity computing device 130 may generate an objective function configured to minimize various costs, as indicated below:

$$arg min {\sum }_{w = 1}^{7} {\sum }_{r = 1}^{R} {\sum }_{l = 1}^{L} {\sum }_{h = 1}^{24} {N}_{rhlw} * {C}_{rhlw} \qquad ( 9 )$$

where N_{rhlw} (a decision variable) may indicate a number of personnel (e.g., agents) of role r starting a shift on day of week w and start hour h with shift length l, and C_{rhlw} indicates a total cost associated with role r of shift on day of week w and start hour h with shift length l.

Still further, the entity computing device 130 may establish personnel count restraints as part of the optimization block 206, and as indicated in the constraints 210. Personnel count (i.e., headcount) constraints may play a critical role in scheduling optimization, ensuring that the number of personnel assigned to a specific role does not exceed the maximum allowable limit. These personnel count constraints may include, for example, factors such as the available workforce, legal restrictions, and operational requirements. By incorporating headcount constraints, the entity computing device 130 may develop optimized schedules 214 that effectively balance demand while adhering to the established limitations.

The entity computing device 130 may incorporate personnel count constraints by analyzing the total number of personnel available for each role and any restrictions on the number of personnel that can be assigned to a role within a given time period. Furthermore, the entity computing device 130 may analyze any maximum or minimum requirements for each role to guarantee that the workforce is efficiently utilized. Thus, by addressing personnel count constraints, the resulting optimization model 136d may ensure that the workforces capabilities are fully leveraged while preventing overstaffing or understaffing scenarios. This approach allows the entity computing device 130 to create more accurate and efficient schedules than conventional techniques that do not consider such count constraints and minimizes the risk of violating legal or operational restrictions, thereby fostering a compliant and well-organized work environment. In particular, the entity computing device 130 may account for and/or otherwise analyze these personnel count constraints using the following equations including decision variables and corresponding different groups (e.g., roles and offices):

$$C \leq {\sum }_{i ∈ S} {HC}_{i} \qquad ( 10 )$$

$$C \geq {\sum }_{i ∈ S} {HC}_{i} \qquad ( 11 )$$

where S may be the subset of schedules, HCᵢ may be the personnel count assigned to the schedule, and C may be the given constraint for the total personnel count.

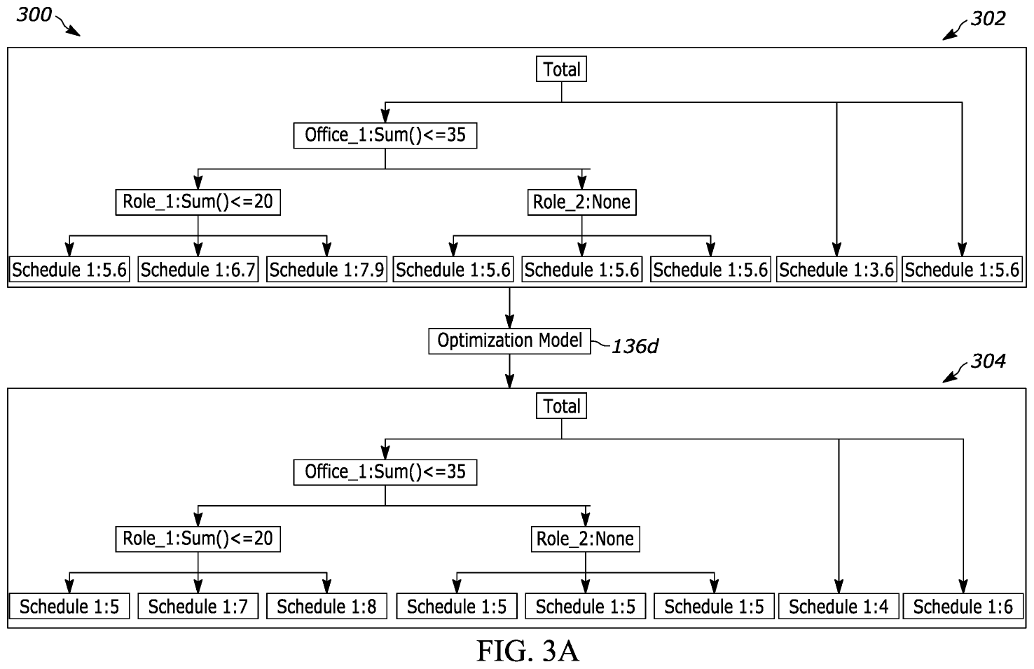

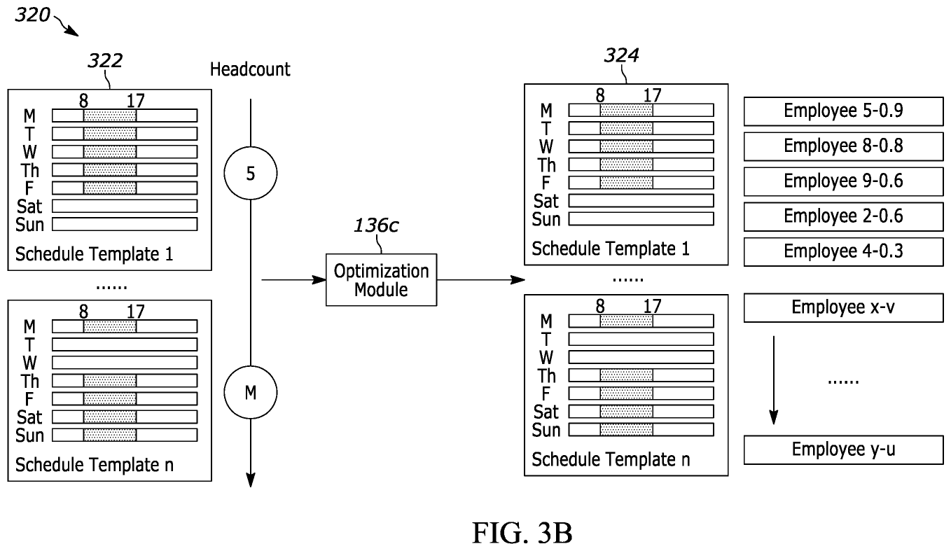

In any event, when the entity computing device 130 analyzes these various constraints, the device 130 may proceed to round the optimization results. More specifically, FIG. 3A depicts a post-processing function with a rounding step associated with forward looking scheduling, in accordance with some embodiments. Broadly speaking, the entity computing device 130 may perform at least two distinct optimization scenarios: integer optimization, continuous optimization with a postprocessing rounding step, and/or any other suitable optimization scenario or combinations thereof. The first of these scenarios, including an integer CBC solver, may guarantee strict adherence to all given constraints through a clear logic. By contrast, the second scenario significantly reduces runtime relative to conventional techniques and may identify feasible scheduling solutions in cases where integer optimization fails to work. Such complex cases typically involve thousands of decision variables, making the problem too expensive for integer optimization.

To address these inadequacies of conventional integer optimization, the entity computing device 130 may generally round optimization results using a two-step approach: continuous optimization with all given constraints based on a default CBC solver, and rounding these outputs from the default CBC solver based on headcount constraints and a mapping structure for generated schedules.

In the first step, the entity computing device 130 may receive values indicating various roles, schedules, personnel count, offices, and/or other suitable variables that the entity computing device 130 may output as part of the operation of the optimization model 136d, as described above. As mentioned, the entity computing device 130 may enforce constraints for different groups of schedules (e.g., roles, offices) and/or may not have any constraints for a given schedule. Thus, the entity computing device 130 may create a solution for rounding logic which respects the particular variety of constraints (referenced herein as a “tree of constraints”) applied to each individual group of schedules included as part of the rounding process. For example, as illustrated in the first optimization output 302 in FIG. 3A, the output schedules may each have non-integer personnel count values (e.g., “5.6”, “6.7”, etc.), and each of these schedules may be subject to different sets of constraints (e.g., “Role_1: sum( )<=20”, “Role_2: None”).

The entity computing device 130 may execute the rounding logic as part of the optimization model 136d to adhere to all personnel count-related constraints by executing a rounding algorithm. The rounding algorithm may include various steps for a single node while iterating through the tree of constraints from leaves to the root (i.e., “total”). Initially, the entity computing device 130 may verify whether the leaf has a constraint. If the leaf does have a corresponding constraint, the entity computing device 130 may assign a constraint number to the leaf. Otherwise, the entity computing device 130 may move on to another leaf. However, if the leaf lacks a constraint and has no parent leaf, the entity computing device 130 may set a sum value to capture the root and round all ungrouped values.

Subsequently, the entity computing device 130 may calculate the sum of all leaf values with floor rounding and determine a difference value to yield the number of leaves remaining to round up. The entity computing device 130 may then sort all leaves in ascending order by their mantissa value and round up a certain number of leaves and round down all other leaves. Afterwards, the entity computing device 130 may proceed to the next leaf. As a result, the entity computing device 130 may obtain rounded personnel count values that respect any corresponding constraints. For example, as shown in the second optimization output 304 from the optimization model 136d including the rounding algorithm, the output schedules may each have integer personnel count values (e.g., “5”, “7”, etc.).

With the optimized and rounded outputs from the optimization block 206, the entity computing device 130 may proceed to match specific personnel with available roles in the schedules at the personnel matching block 208. The personnel matching block 208 broadly includes predicting whether a particular personnel is likely to accept and/or perform well when assigned to a particular role for a particular duration and shift within the optimized schedule templates output by the optimization model 136d.

To illustrate the functions performed in the personnel matching block 208, FIG. 3B depicts an example personnel prediction and matching 320 with an output optimized schedule, in accordance with some embodiments. At a first time 322, the optimized schedule templates and personnel count values output by the optimization model 136d may be analyzed by the optimization module 136c, which may include executable instructions necessary to optimally match available personnel to shifts in such optimized schedule templates. Namely, the entity computing device 130 may execute the executable instructions included as part of the optimization module 136c to fit specific personnel with the shifts represented in the schedule templates based on the personnel count values, the schedule templates, historical schedule templates, and historical acceptance/performance values of various personnel related to the historical schedule templates.

For example, each personnel available for matching with a schedule template may have a historical acceptance/performance record with multiple types of potential schedule templates (e.g., and the particular shift configurations embodied therein). In certain embodiments, this historical acceptance/performance record may indicate successful/unsuccessful acceptance/performance in a binary manner (e.g., one or zero) and/or in any other suitable manner or combinations thereof. Thus, the entity computing device 130 may predict whether particular personnel may accept and/or perform adequately in a particular shift and/or within a particular schedule based on the historical acceptance/performance record of that specific personnel and/or a relative similarity of the schedule template to the historical schedule templates.

Accordingly, the entity computing device 130 may execute the instructions included as part of the optimization module 136c to output the personnel matched results at the second time 324. As illustrated in FIG. 3B, the personnel matched results include a set of personnel that the entity computing device 130 predicts may adequately fill shifts within the corresponding schedule template and may also provide an associated confidence value (e.g., “0.9”, “0.8”, etc.) indicating the relative confidence that the personnel may accept and/or adequately perform one or more shifts indicated in the corresponding schedule template (e.g., schedule template 1). The entity computing device 130 may generate similar predictive lists of matched personnel for each schedule template output by the optimization model 136d.

Moreover, and returning to FIG. 2, these personnel matched results included as part of the optimized schedules 214 may be used to inform the historical acceptance/performance records for future iterations of the exemplary workflow 200. Thus, the outputs from the personnel matching block 208 may be evaluated 212 and included in subsequent demand data preparation 202 and/or schedules data preparation 204 functions.

FIG. 4 depicts an exemplary graphical user interface (GUI) 400 featuring an optimized schedule with corresponding available supply (e.g., set of associated personnel counts 404) by time intervals, in accordance with some embodiments. The exemplary GUI 400 may generally include a set of optimized schedules 402, a set of associated personnel counts 404, and a set of role distributions 406. These features of the exemplary GUI 400 may be or include any relevant inputs/outputs to/from the schedules data preparation module 136a, the demand data preparation module 136b, the optimization module 136c, the optimization model 136d, and/or any other suitable components described herein or combinations thereof.

The set of optimized schedules 402 may be or include multiple optimized schedules for a single role, from which the user may choose, and/or multiple optimized schedules for a variety of roles. For example, in the set of optimized schedules 402, there may be three different optimized schedules for a first role (“Role 1”), a second role (“Role 2”), and a third role (“Role 3”), and each optimized schedule may have a certain number of shifts of potentially varying lengths across a single work week. In this example, a user viewing this exemplary GUI 400 may examine the set of optimized schedules and determine which one of the numerous potential schedules the user would prefer for the first role, the second role, and/or the third role.

To assist the user in this determination, the exemplary GUI 400 may also include the set of associated personnel counts 404. The user may examine the set of associated personnel counts 404 to determine how many personnel may be required to optimally staff the corresponding work schedule. For example, if the user decides to select the first schedule for the first role, the user may require at least five personnel to adequately staff the shifts during that week. In this manner, the user may quickly gain an appreciation for the shift timings and personnel count requirements to optimally staff the coming work week (and/or any other suitable period).

Additionally, the exemplary GUI 400 may include the set of role distributions 406, which may generally indicate the distribution of personnel required (i.e., demand) and/or performing a particular role during each hour of a given workday. The user may examine this set of role distributions 406 to determine what periods during a particular day mar require additional personnel and/or how to select an optimal schedule based on length, nature, and/or other characteristics of the busy/quiet periods for particular roles.

In certain embodiments, the user interacting (e.g., tap, click, swipe, gesture, voice command, etc.) with any portion of the exemplary GUI 400 may cause the corresponding device (e.g., user computing device 122, entity computing device 130) to transition to a separate interface where the user may communicate directly/indirectly with personnel to communicate scheduling requests. For example, the user may interact with the set of optimized schedules 402, the set of associated personnel counts 404, and/or the set of role distributions 406, and the computing device may automatically generate a message, such as electronic mail, or other communication (e.g., calendar invitation, text message) indicating to specific personnel the user's request for staffing during the indicated shifts/days.

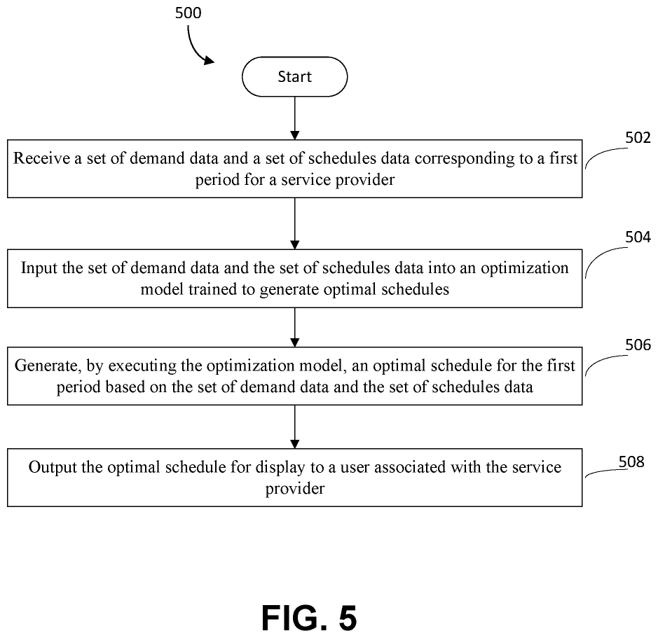

FIG. 5 is a block diagram illustrating an example method 500 of leveraging artificial intelligence for forward looking scheduling, in accordance with some embodiments. The method 500 may be facilitated by an electronic device (such as the entity computing device 130 as depicted in FIG. 1B). In embodiments, the electronic device may communicate with a set of data sources and a set of additional electronic devices.

The method 500 may include receiving, at one or more processors, a set of demand data and a set of schedules data corresponding to a first period for a service provider (block 502). In certain embodiments, the set of schedules data may be or include a set of shift constraints (e.g., allowable shifts per week, shift length values, etc.). The method 500 may further include inputting, by the one or more processors, the set of demand data and the set of schedules data into an optimization model trained to generate optimal schedules based on a set of training demand data and a set of training schedules data (block 504).

The method 500 may further include generating, by the one or more processors executing the optimization model, an optimal schedule for the first period based on the set of demand data and the set of schedules data (block 506). The method 500 may further include outputting, by the one or more processors, the optimal schedule for display to a user associated with the service provider (block 508).

In some embodiments, the method 500 may further comprise: receiving, at the one or more processors, a set of volume data and a set of average handle time data corresponding to a historical period for the service provider; and generating, by the one or more processors executing a demand model, the set of demand data based on the set of volume data and the set of average handle time data, wherein the set of demand data defines minimum supply requirements for the service provider during the first period. Further in these embodiments, the method 500 may further comprise: filtering, by the one or more processors executing the demand model, the set of demand data by: (i) adding a shrinkage value to the set of demand data, (ii) applying a smoothing technique to peaks in the set of demand data exceeding a threshold value, (iii) redistributing demand volume based on a service level agreement (SLA), or (iv) loosening demand constraints at one or more intervals of the first period.

In certain embodiments, the method 500 may further comprise: receiving, at the one or more processors, a set of period constraints corresponding to the first period; and generating, by the one or more processors executing a scheduling model, one or more schedule templates based on the set of period constraints, wherein the set of schedules data comprises the one or more schedule templates. Further in these embodiments, the set of period constraints may comprise: (i) an allowable working days value, (ii) a shifts per week value, (iii) a permissible start times value, (iv) a start time allowed variance value, (v) a maximum unique start time value, (vi) a shift length value, (vii) a maximum unique shift length value, (viii) a non-permissible working hours value, (ix) a minimum weekly hours value, (x) a maximum weekly hours value, (xi) a maximum over time value, (xii) a maximum continuous days off value, or (xiii) a break time per shift value.

In some embodiments, generating the optimal schedule may further comprise: generating, by the one or more processors, a head count vector based on the set of demand data; generating, by the one or more processors, a schedules matrix based on the set of schedules data; and generating, by the one or more processors, the optimal schedule by multiplying the schedules matrix with the head count vector.

In certain embodiments, the optimal schedule may comprise a plurality of optimal schedules, and the method 500 may further comprise: generating, by the one or more processors executing the optimization model, a set of personnel assignments for each schedule of the plurality of optimal schedules.

In some embodiments, the method 500 may further comprise: generating, by the one or more processors executing the optimization model, a cost value corresponding to the optimal schedule.

It should be appreciated that the steps of the method 500 have been described herein as part of an ordered sequence for the purposes of discussion only. Each of the steps of the method 500 may be performed in any suitable order and for any suitable number of times to achieve an optimal schedule.

### Additional Considerations

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of leveraging artificial intelligence (AI) for forward looking scheduling, the computer-implemented method comprising:
receiving, at one or more processors, a set of demand data and a set of schedules data corresponding to a first period for a service provider;
inputting, by the one or more processors, the set of demand data and the set of schedules data into an optimization model trained to generate optimal schedules based on a set of training demand data and a set of training schedules data;
generating, by the one or more processors executing the optimization model, an optimal schedule for the first period based on the set of demand data and the set of schedules data; and
outputting, by the one or more processors, the optimal schedule for display to a user associated with the service provider.

2. The computer-implemented method of claim 1, further comprising:
receiving, at the one or more processors, a set of volume data and a set of average handle time data corresponding to a historical period for the service provider; and
generating, by the one or more processors executing a demand model, the set of demand data based on the set of volume data and the set of average handle time data, wherein the set of demand data defines minimum supply requirements for the service provider during the first period.

3. The computer-implemented method of claim 2, further comprising:
filtering, by the one or more processors executing the demand model, the set of demand data by:
(i) adding a shrinkage value to the set of demand data,
(ii) applying a smoothing technique to peaks in the set of demand data exceeding a threshold value,
(iii) redistributing demand volume based on a service level agreement (SLA), or
(iv) loosening demand constraints at one or more intervals of the first period.

4. The computer-implemented method of claim 1, further comprising:
receiving, at the one or more processors, a set of period constraints corresponding to the first period; and
generating, by the one or more processors executing a scheduling model, one or more schedule templates based on the set of period constraints,
wherein the set of schedules data comprises the one or more schedule templates.

5. The computer-implemented method of claim 4, wherein the set of period constraints comprises: (i) an allowable working days value, (ii) a shifts per week value, (iii) a permissible start times value, (iv) a start time allowed variance value, (v) a maximum unique start time value, (vi) a shift length value, (vii) a maximum unique shift length value, (viii) a non-permissible working hours value, (ix) a minimum weekly hours value, (x) a maximum weekly hours value, (xi) a maximum over time value, (xii) a maximum continuous days off value, or (xiii) a break time per shift value.

6. The computer-implemented method of claim 1, wherein generating the optimal schedule further comprises:
generating, by the one or more processors, a head count vector based on the set of demand data;
generating, by the one or more processors, a schedules matrix based on the set of schedules data; and
generating, by the one or more processors, the optimal schedule by multiplying the schedules matrix with the head count vector.

7. The computer-implemented method of claim 1, wherein the optimal schedule comprises a plurality of optimal schedules, and the computer-implemented method further comprises:
generating, by the one or more processors executing the optimization model, a set of personnel assignments for each schedule of the plurality of optimal schedules.

8. The computer-implemented method of claim 1, further comprising:
generating, by the one or more processors executing the optimization model, a cost value corresponding to the optimal schedule.

9. A system leveraging artificial intelligence (AI) for forward looking scheduling, comprising:
a memory storing a set of computer-readable instructions including an optimization model; and
one or more processors interfaced with the memory, and configured to execute the set of computer-readable instructions to cause the one or more processors to:
receive a set of demand data and a set of schedules data corresponding to a first period for a service provider,
input the set of demand data and the set of schedules data into an optimization model trained to generate optimal schedules based on a set of training demand data and a set of training schedules data,
generate, by executing the optimization model, an optimal schedule for the first period based on the set of demand data and the set of schedules data, and
output the optimal schedule for display to a user associated with the service provider.

10. The system of claim 9, wherein the computer-readable instructions, when executed, further cause the one or more processors to:
receive a set of volume data and a set of average handle time data corresponding to a historical period for the service provider; and
generate, by executing a demand model, the set of demand data based on the set of volume data and the set of average handle time data, wherein the set of demand data defines minimum supply requirements for the service provider during the first period.

11. The system of claim 10, wherein the computer-readable instructions, when executed, further cause the one or more processors to:
filter, by executing the demand model, the set of demand data by:
(i) adding a shrinkage value to the set of demand data,
(ii) applying a smoothing technique to peaks in the set of demand data exceeding a threshold value,
(iii) redistributing demand volume based on a service level agreement (SLA), or
(iv) loosening demand constraints at one or more intervals of the first period.

12. The system of claim 9, wherein the computer-readable instructions, when executed, further cause the one or more processors to:
receive a set of period constraints corresponding to the first period; and
generate, by executing a scheduling model, one or more schedule templates based on the set of period constraints,
wherein the set of schedules data comprises the one or more schedule templates.

13. The system of claim 12, wherein the set of period constraints comprises: (i) an allowable working days value, (ii) a shifts per week value, (iii) a permissible start times value, (iv) a start time allowed variance value, (v) a maximum unique start time value, (vi) a shift length value, (vii) a maximum unique shift length value, (viii) a non-permissible working hours value, (ix) a minimum weekly hours value, (x) a maximum weekly hours value, (xi) a maximum over time value, (xii) a maximum continuous days off value, or (xiii) a break time per shift value.

14. The system of claim 9, wherein the computer-readable instructions, when executed, further cause the one or more processors to:
generate a head count vector based on the set of demand data;
generate a schedules matrix based on the set of schedules data; and
generate the optimal schedule by multiplying the schedules matrix with the head count vector.

15. The system of claim 9, wherein the optimal schedule comprises a plurality of optimal schedules, and the computer-readable instructions, when executed, further cause the one or more processors to:
generate, by executing the optimization model, a set of personnel assignments for each schedule of the plurality of optimal schedules.

16. A non-transitory computer-readable storage medium configured to store instructions executable by one or more processors, the instructions comprising:
instructions for receiving a set of demand data and a set of schedules data corresponding to a first period for a service provider;
instructions for inputting the set of demand data and the set of schedules data into an optimization model trained to generate optimal schedules based on a set of training demand data and a set of training schedules data;
instructions for generating, by executing the optimization model, an optimal schedule for the first period based on the set of demand data and the set of schedules data; and
instructions for outputting the optimal schedule for display to a user associated with the service provider.

17. The non-transitory computer-readable storage medium of claim 16, wherein the instructions further comprise:
instructions for receiving a set of volume data and a set of average handle time data corresponding to a historical period for the service provider; and
instructions for generating, by executing a demand model, the set of demand data based on the set of volume data and the set of average handle time data, wherein the set of demand data defines minimum supply requirements for the service provider during the first period.

18. The non-transitory computer-readable storage medium of claim 17, wherein the instructions further comprising:
instructions for filtering, by executing the demand model, the set of demand data by:
(i) adding a shrinkage value to the set of demand data,
(ii) applying a smoothing technique to peaks in the set of demand data exceeding a threshold value,
(iii) redistributing demand volume based on a service level agreement (SLA), or
(iv) loosening demand constraints at one or more intervals of the first period.

19. The non-transitory computer-readable storage medium of claim 16, wherein the instructions further comprise:
instructions for receiving a set of period constraints corresponding to the first period; and
instructions for generating, by executing a scheduling model, one or more schedule templates based on the set of period constraints,
wherein the set of schedules data comprises the one or more schedule templates, and
wherein the set of period constraints comprises: (i) an allowable working days value, (ii) a shifts per week value, (iii) a permissible start times value, (iv) a start time allowed variance value, (v) a maximum unique start time value, (vi) a shift length value, (vii) a maximum unique shift length value, (viii) a non-permissible working hours value, (ix) a minimum weekly hours value, (x) a maximum weekly hours value, (xi) a maximum over time value, (xii) a maximum continuous days off value, or (xiii) a break time per shift value.

20. The non-transitory computer-readable storage medium of claim 16, wherein the instructions further comprise:
instructions for generating a head count vector based on the set of demand data;
instructions for generating a schedules matrix based on the set of schedules data; and
instructions for generating the optimal schedule by multiplying the schedules matrix with the head count vector.
